(19) United States
(12) Patent Application Publication
(10) Pub. No.: US 2007/0165968 A1
(43) Pub. Date: Jul. 19, 2007

(54) Image editing system and image editing program

(75) Inventor: Hajime Terayoko, Saitama (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 11/654,604

(22) Filed: Jan. 18, 2007

(30) Foreign Application Priority Data
Jan. 19, 2006 (JP) 2006-011585

(51) Int. Cl. G06K 9/54

(52) U.S. Cl. 382/305

(57) ABSTRACT

An image editor is provided with a CPU, a ROM, a RAM, an LCD panel, an operating section, a memory card reader and an HDD. The HDD stores a landmark database and a contents database. Before writing data of an image in a memory card, position data indicating a camera location, at which the image is captured, is attached to the image data. When the image data and the attached position data are read through the memory card reader, the CPU searches the landmark database based on the position data, and sorts the image data into groups according to the retrieved landmark data. Then the CPU retrieves such contents data that relate to the landmark data from the contents database. Using the grouped image data and the retrieved contents data, the image editor produces a digital photo-album or a digital photo-movie.

### FIELD OF THE INVENTION

The present invention relates to a system and a program for editing image data of a plural number of images to compose an image product such as an electronic album or a digital photo-movie.

### BACKGROUND OF THE INVENTION

Digital cameras have recently been widely used, which can capture images as image data through an imaging device, stores the image data in a storage medium, and display the captured images on a display like an LCD. Since the user of the digital camera can observe the captured images on the display without the need for printing the image on the paper, the image data would not degrade unlike the photo-prints. However, with regard to the efficiency of sorting and arranging the images, the image data is inferior to the photo-prints, because the user can appropriately put the photo-prints in order by filing them into albums or the like. If the image data is stored without being put in order, it becomes difficult to remember afterward when and in what event the pictures have been taken.

Meanwhile, it has recently been popular to edit the image data, as captured by the digital camera, using information on contents including texts, pictures, videos and sounds, as disclosed for example in Japanese Laid-open Patent Application Nos. 2004-289825 and 2005-128785. Furthermore, a digital camera or camera as disclosed in Japanese Laid-open Patent Application No. 2004-289825 gets position data indicating a camera location of each shot, through a built-in GPS (Global Positioning System) terminal, and memorizes the position data in association with the captured image. The digital camera or camera of this prior art is also provided with a processor and an interface that is accessible to a database storing information on the contents relating to the camera location, so that the processor may edit the image by use of the contents information obtained from the database.

Also a digital camera disclosed in Japanese Laid-open Patent Application No. 2005-128785 gets conditional information, indicating the camera location and the date and time of each shot through a built-in GPS terminal, and memorizes the conditional information in association with the image data. This prior art also mentions that the user purchases a recording medium like CD in tourist spots, which records material information (data of contents) relating to the tourist spots and a specific program as well. Using the material information and the program recorded on the recording medium, the user can produce an electronic album, hereinafter referred to as a digital photo-album, from the image data captured by the digital camera. The program recorded on the recording medium makes it possible to decide automatically or select manually a picture to be displayed on an opening (top cover) of the electronic album, on the basis of the conditional information, such as the camera location and the date and time, as recorded with the image data prepared by the user.

Accordingly, by use of the contents data, it becomes possible to edit data of a large number of images as captured by the digital camera, to produce a digital photo-album. The contents data also make it possible to produce a digital photo-movie by editing data of a large number of images into moving images. By producing the digital photo-album or digital photo-movie from a large number of captured images, the user can put the data of the captured images in order into a data unit. Furthermore, the user can add some interesting factors to the original image data by use of such program that adds funny motions to the pictures, or such contents data as music suitable for the pictures. Thereby, it becomes possible to produce image products like digital photo-movies and digital photo-albums that give more pleasure to the user.

Note that the digital photo-movie is a pseudo movie that is produced by editing data of still images so that pictures look as if they move. Electronic zooming is a concrete example of the image editing process for the digital photo-movie, whereby a still image is partly cropped and gradually enlarged for close-up. Another example is electronic pane process, whereby the position of a cropping pane moves from an end to another end of the original still image, as if the point of view moves across a scene captured in the original still image. As other examples of the image editing process for the digital photo-movie, image-composing with an ornamental image, and motion-giving process for putting the still picture frame itself into straight-forward motion or rotation may also be referred to. Thus, giving these special effects to the still images produces the digital photo-movie.

However, the above-mentioned prior arts need certain time and labor for producing an image product from a large number of images. According to the latter prior art, the user must select suitable contents data for the image data from among those recorded on the recording medium, and edit the image data with the contents data to produce a digital photo-album or digital photo-movie. Although both of the above prior arts permit gathering data of a large number of images as a digital photo-album or digital photo-movie, the user must enter data for arrangement and layout of the images inside the digital photo-movie or digital photo-album. Therefore it is difficult to edit the image data according to the camera locations, to produce an image product like a digital photo-movie or digital photo-album in such a manner that enhances the value of the product as a memorial or amusement. Moreover, the digital camera disclosed in the former prior art can merely obtain suitable contents data for each individual image, but does not consider utilizing the contents data for gathering image data of a large number of images into an image product like an album. So it takes time and labor for producing the image product.

### SUMMARY OF THE INVENTION

In view of the foregoing, a primary object of the present invention is to provide an image editing system and an image editing program, which facilitate editing the image data according to the camera locations, and producing image products like digital photo-albums and digital photo-movies in such a manner that enhances the value of the image products as memorials or entertainments.

In an image editing system for editing image data, wherein position data is attached to the image data, indicating a camera location at which each image is captured, the present invention comprises a landmark database storing data of a variety of landmarks, including locations and names of the landmarks; a contents database storing contents data that include data relating to the respective landmarks and data for giving some effect to the images; a device for obtaining the image data of a plural number of images along with the position data; a search device for searching the landmark database, to retrieve such landmark data based on the position data that relates to the camera location of each image; a sorting device for sorting the image data into groups according to the retrieved landmark data, while associating the retrieved landmark data with the corresponding image data; and an image editing device that obtains from the contents database such contents data that relates to the landmark data associated with the image data of one group, to edit the image data of this group by use of the obtained contents data.

The landmark data preferably include data of inclusive relation between the landmarks, and the image editing device reads the contents data sequentially from those relating to a larger place or landmark to those relating to a smaller place or landmark that is located in the larger place or landmark, to edit the corresponding image data by use of the contents data for the larger place or landmark, and the contents data for the smaller place or landmark in combination.

According to a preferred embodiment, the image editing system further comprises a device for setting priority among a plural number of landmarks as retrieved based on the position data for one image, and a device for selecting a landmark from among the plural number of landmarks as displayed in a sequence according to the set priority. Preferably, among the landmarks retrieved for one image, the nearer landmark to the camera location of the one image is given the higher priority.

An image editing program of the present invention makes a computer execute the following processes of obtaining the image data of a plural number of images along with the position data; searching a landmark database based on the position data, the landmark database storing data including locations and names of a variety of landmarks, to retrieve data of at least a landmark that relates to the camera location of each image; sorting the image data into groups according to the retrieved landmark data, while associating the retrieved landmark data with the image data; obtaining from a contents data base such contents data that relates to the landmark data associated with the image data of one group, the contents database storing contents data that include data relating to the respective landmarks and data for giving some effect to the images; and editing the image data of the one group by use of the obtained contents data.

Because the present invention produces an image product, such as a digital photo-album or photo-movie, after sorting the images into groups according to the landmark data that is retrieved based on the position data, the digital photo-album or photo-movie produced by the image editing system of the present invention facilitates reminding the user of the events shot in the pictures.

Because the present invention obtains and uses such contents data that relates to the retrieved landmark data for editing the image data, the present invention makes it possible to edit a large number of images automatically to have suitable contents for the camera locations of the respective images, and thus makes it easy to produce highly-entertaining image products.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a block diagram illustrating a digital camera and an image editor according to an embodiment of the present invention;

FIG. 2 is an explanatory diagram illustrating an example of an image sorting screen displayed on a display device of the image editor;

FIG. 3 is an explanatory diagram illustrating an example of an image confirming screen displayed on the display device of the image editor;

FIG. 4 is an explanatory diagram of map data;

FIG. 5 is an explanatory diagram of a map division data table;

FIG. 6 is an explanatory diagram of a divisional area index table;

FIG. 7 is an explanatory diagram of a landmark data table;

FIG. 8 is a plan view illustrating 2-D area data of a theme park;

FIG. 9 is a plan view illustrating 2-D area data of a Ferris wheel;

FIG. 10 is a plan view illustrating 2-D area data of a roller coaster;

FIG. 11 is an explanatory diagram illustrating an example of a folder structure of image files sorted by the image editor;

FIG. 12 is a plan view illustrating an example of a top cover image of a digital photo-album edited by the image editor;

FIG. 13 is a plan view illustrating an example of a page layout of the digital photo-album edited by the image editor;

FIG. 14 is a flow chart illustrating a sequence of operation of the image editor for producing a digital photo-album;

FIG. 15 is a flow chart illustrating a sequence of deciding page layout of the digital photo-album;

FIG. 16 is a flow chart illustrating of a sequence of operation of the image editor for producing a digital photo-movie; and

FIG. 17 is a flow chart illustrating a sequence of producing data of moving images for the digital photo-movie.

### DESCRIPTION OF THE PREFERRED EMBODIMENTS

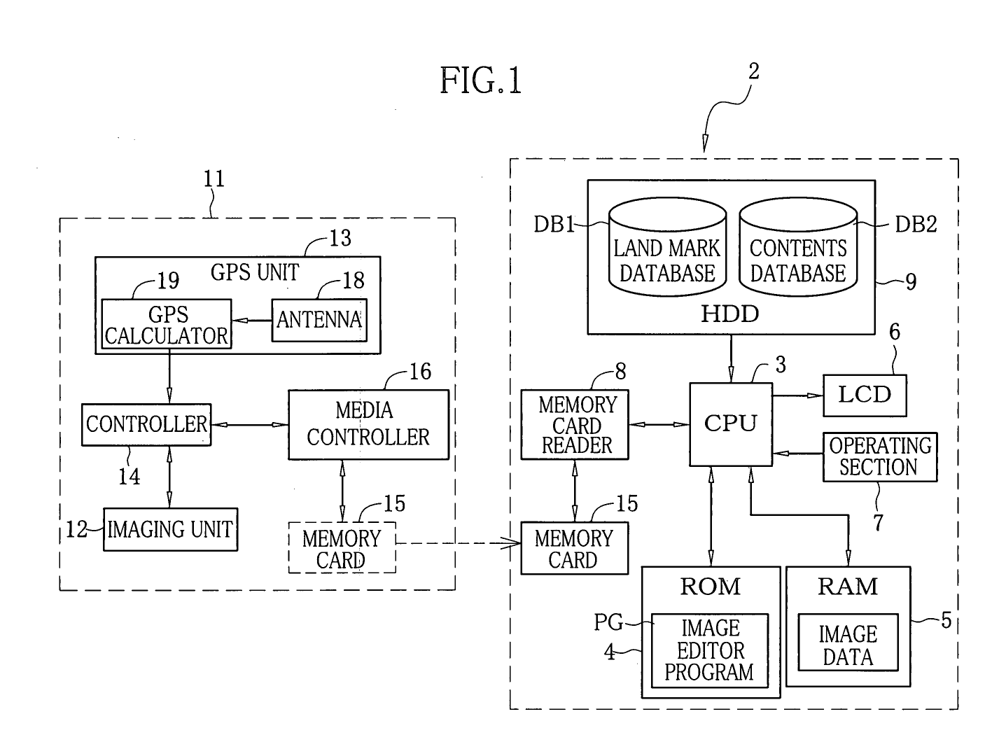

As shown in FIG. 1, an image editor 2 according to an embodiment of the present invention is constituted of a personal computer that is provided with a CPU 3, a ROM 4, a RAM 5, an LCD panel 6, an operating section 7, a memory card reader 8 and an HDD 9. As described in detail later, the CPU 3 functions as a search device, an image data grouping device and an image editing device as well. The operating section 7 consists of a keyboard, a mouse and the like, and is operated to input data in the CPU 3.

As set forth later, the RAM 5 stores image data, position data attached to the image data at each shot, and landmark data relating to the position data, among which the image data and the position data are obtained by the digital camera 11 and transferred to the RAM 5 by way of a memory card 15.

The HDD 9 stores landmark database DB1 and contents database DB2, which are used respectively during a landmark data search process and a contents data obtaining process, as set forth later.

First, the digital camera 11 will be described. The digital camera 11 is an imaging device that captures images and records data of captured images on the memory card 5. The digital camera 11 is provided with an imaging unit 12 that comprises a shutter button and a taking lens in a conventional manner, a GPS terminal 13 for locating a present camera location and getting position data of the present camera location, a controller 14 and a media controller 16 for use in writing data on the memory card 15. The memory card 15 is detachably attached to a not-shown memory card slot of the digital camera 11. The GPS terminal 13 has an antenna 18 and a GPS calculator 19. The antenna 18 is for receiving electric waves from a GPS satellite that is moving around the earth. The received electric wave is sent to the GPS calculator 19, which stores a calculation program for calculating based on the electric wave the present position of the digital camera 11, i.e. latitude and longitude of the present position.

When an image is captured by operating the imaging unit 12, the controller 14 outputs a program activation signal to the GPS calculator 19, so the GPS calculator 19 activates the calculation program to calculate latitude and longitude of the present camera position on the basis of the electric wave. Then the GPS calculator 19 sends data of the calculated position to the controller 14, so the controller 14 attaches the position data from the GPS calculator 19 to the image data of the captured image, to produce an image file, and thereafter writes the image file in the memory card 15.

The memory card 15 having a plural number of image files stored therein is removed from the digital camera 11, and is loaded in the memory card reader 8 of the image editor 2. Then the CPU 3 reads the image files from the memory card 15 and writes the read image files temporarily in the RAM 5. Then, based on the position data attached to the image data, the CPU 3 retrieves landmark data relating to the position data and attaches the retrieved landmark data to the image data. Thereafter, the image files are rewritten in the RAM 5.

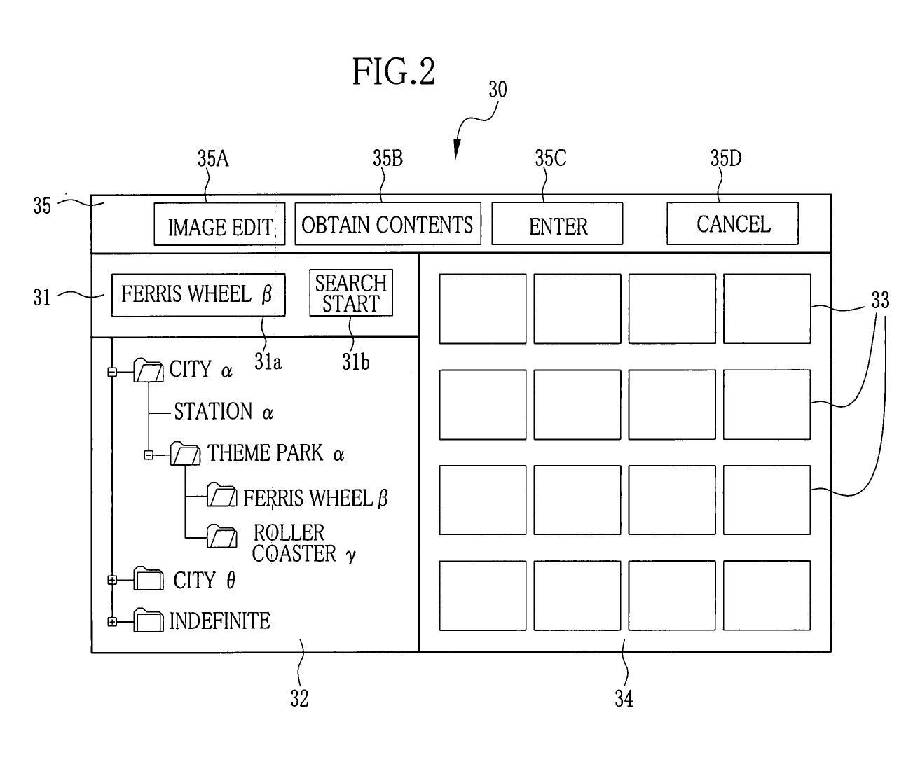

The ROM 7 stores an image editor program, which is activated when a command signal for starting the image editor program is entered by operating the operating section 7. For example, an icon indicating the image editor program is clicked on a GUI (Graphical User Interface) screen of the LCD panel 6, the image editor program is activated. It is alternatively possible to activate the image editor program automatically when the memory card 15 is set in the memory card reader 8. When the image editor program is activated, the LCD panel 6 first displays an image sorting screen 30 as shown in FIG. 2.

The image sorting screen 30 displays a search window 31, an explorer window 32, a thumbnail window 34, and an operation menu window 35. The explorer window 32 displays a list of folder names as a folder tree, the folder names correspond to landmark names determined by the landmark data attached to the respective image data. When one of the folders is chosen by clicking a cursor pointer 36 on the folder in the explorer window 32, the thumbnail window 34 displays thumbnail images 33 of those image files which are held in the chosen folder. Or when a keyword like a landmark name is entered in the search window 31, the thumbnail window 34 displays thumbnail images 33 of those image files which relate to the keyword, namely, the image files held in the folder having the entered landmark name.

In the illustrated example, the folders displayed in the explorer window 32 correspond to the landmark data stored in the landmark database DB1, including landmark names such as city α, station α, theme park α, Ferris wheel β, roller coaster γ and city θ, and the folder for indefinite or unidentified places.

The station α and the theme park α are landmarks which are located in the city α, so the folders for the station α and the theme park α are contained in the folder for the city α. The Ferris wheel β and the roller coaster γ are landmarks which are located in the theme park α, so the folders for the Ferris wheel β and the roller coaster γ are contained in the folder for the theme park α. Accordingly, the folder named city α, the folder named city θ and the folder for indefinite places are in the same grade of the folder tree, and the folder named theme park α is a subfolder to the folder named city α, and the folder named Ferris wheel β and the folder named roller coaster γ are subfolders to the folder named theme park α. In the following description, those landmarks which assigned to the folders of the same branch, e.g. the city α, the station α, the theme park α, the Ferris wheel β and the roller coaster γ, will be referred to as neighboring landmarks.

When the operating section 7 is operated to open the folder named city α, the folder named station α and the folder named theme park α are displayed in the explorer window 32. When the folder named theme park α is opened, the folder named Ferris wheel β and the folder named roller coaster γ are displayed in the explorer window 32. When one of these folders, for example, the folder named Ferris wheel β is selected by operating the operating section 7, a list of those image files which are sorted into the folder named Ferris wheel β are displayed as thumbnail images 33 on the thumbnail window 34.

Into the folder for indefinite places are sorted those image data, to which any related landmarks can not be found and thus it is impossible to sort them into any folders for definite landmarks.

When, for example, a keyword “Ferris wheel β” is entered in a keyword entry box 31a of the search window 31, and a search start button 31b is operated, or when the folder named Ferris wheel β is clicked among the folders displayed in the explorer window 32, the CPU 23 searches the RAM 5 for those image files which relate to the Ferris wheel β, and lets a list of all the retrieved image files displayed as thumbnail images 33 on the thumbnail window 34.

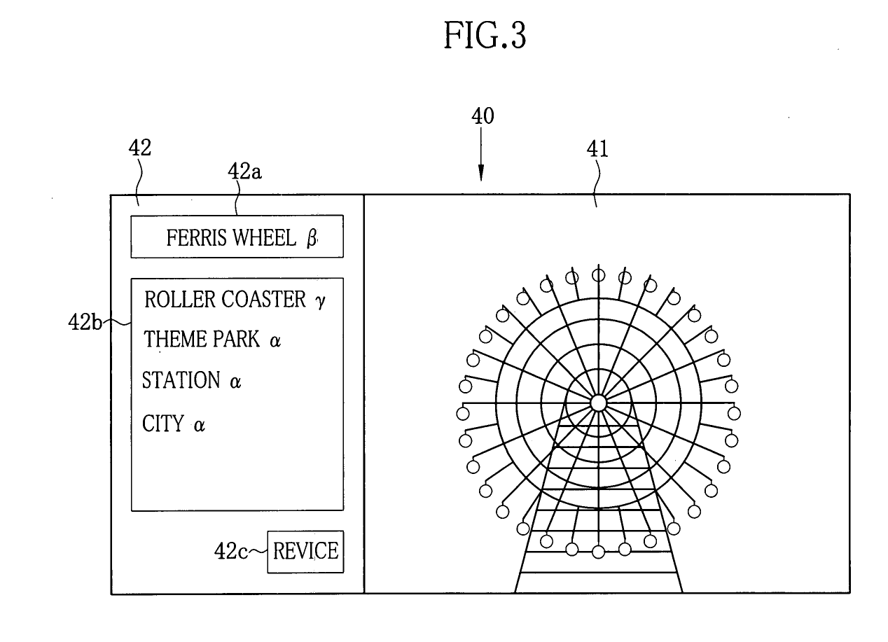

When one of the thumbnail images 33 is chosen on the thumbnail window 34 by operating the operating section 7, the LCD panel 6 switches to an image confirmation screen 40 as shown, for example, in FIG. 3. The image confirmation screen 40 is provided with an image display window 41 and a landmark name revising section 42. The image display window 41 displays an enlarged image of the chosen thumbnail image 33.

The landmark name revising section 42 is provided with a landmark name display box 42a, a name choice section 42b and a landmark name revise button 42c. The landmark name display box 42a displays a landmark name that is designated by landmark name data memorized in the image data of the image presently displayed on the image display window 41. In the illustrated example, “Ferris wheel β” is displayed in the landmark name display box 42a. The name choice section 42b displays a list of the names of the neighboring landmarks sequentially from the nearest to the landmark whose name is displayed in the landmark name display box 42a. For example, as shown in FIG. 3, when “Ferris wheel β” is displayed in the landmark name display box 42a, “roller coaster γ”, “theme park α”, “station α” and “city α” are displayed in this order from the top of the name choice section 42b.

In the present embodiment, the CPU 3 functions as a device for setting priority among the landmarks, wherein the priority is set by the distance from the above-mentioned camera location. That is, the nearest landmark to the camera location comes first on the list displayed in the landmark name revising section 42. However, the priority among the landmarks may be predetermined according to another standard. For example, the priority may be decided based on various data such as population, traffic density of people, opportunity of taking pictures, and so forth. It is also possible to give priority to-those landmarks which include a keyword predetermined by the user. Thus, the priority among the landmarks can be set appropriately.

The CPU 3 functions as a device that permits the user to select a landmark from among a plural number of landmarks as retrieved for one image and displayed in a sequence according to the set priority. As described above, the GPS calculator 19 of the digital camera 11 calculates the position data of the present camera location based on the electric wave received on the antenna 18. Since the calculation based on the electric wave from the GPS satellite is not accurate enough, the position data calculated by the GPS calculator 19 can sometimes indicate a position that deviates from the correct camera location. For example, the calculated position data may indicate a position inside the area of the Ferris wheel β, while the captured image contains the roller coaster γ. In that case, the Landmark data written in the image data of the capture image represents the Ferris wheel β. When this image is chosen to be displayed on the image display section 41, the roller coaster γ is displayed on the image display section 41, while “Ferris wheel β” is displayed in the landmark name display box 42a. If the landmark name displayed in the landmark name display box 42a does not coincide with the image displayed on the image display section 41, it is necessary to correct the landmark name.

In order to correct the landmark name, the operating section 7 is operated to choose a proper one, “roller coaster γ” in this example, from among the landmark names displayed in the name choice section 42b. Then, the chosen landmark name, “roller coaster γ”, is displayed in the landmark name display box 42a. By operating the landmark name revise button 42c in this condition, the CPU 3 rewrites the chosen Landmark data of the roller coaster γ in place of the landmark data of the Ferris wheel β that has been attached to the image data of the image displayed on the image display section 41. In this way, the Landmark data is corrected to coincide with the image. The landmark data may be corrected the same way as the embodiment where the landmark names are displayed in a sequence determined according to another standard than the distance from the camera location.

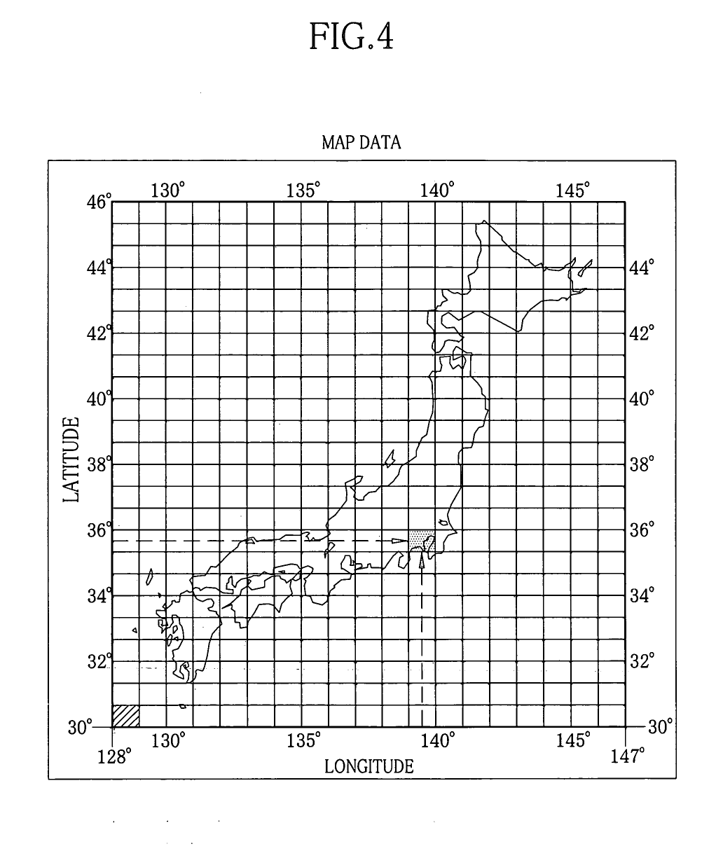

The landmark database DB1 of the HDD 9 stores, for example, data of a schematic 2-D map of Japan. It is possible to store data of a schematic world map in order to obtain data of landmarks of the world. It is also possible to store map data for individual countries, so that the user can chose the map data of one country. As shown in FIG. 4, the map of Japan expressed by the map data covers a map area having a start point at latitude 30° N and longitude 128° E, and an end point at latitude 46° N and longitude 147° E. The map data is divided at 1° interval of longitude and 40′(2/3°) interval of latitude. In other words, the map area is divided into 456 (=19×24) divisional areas in the present embodiment.

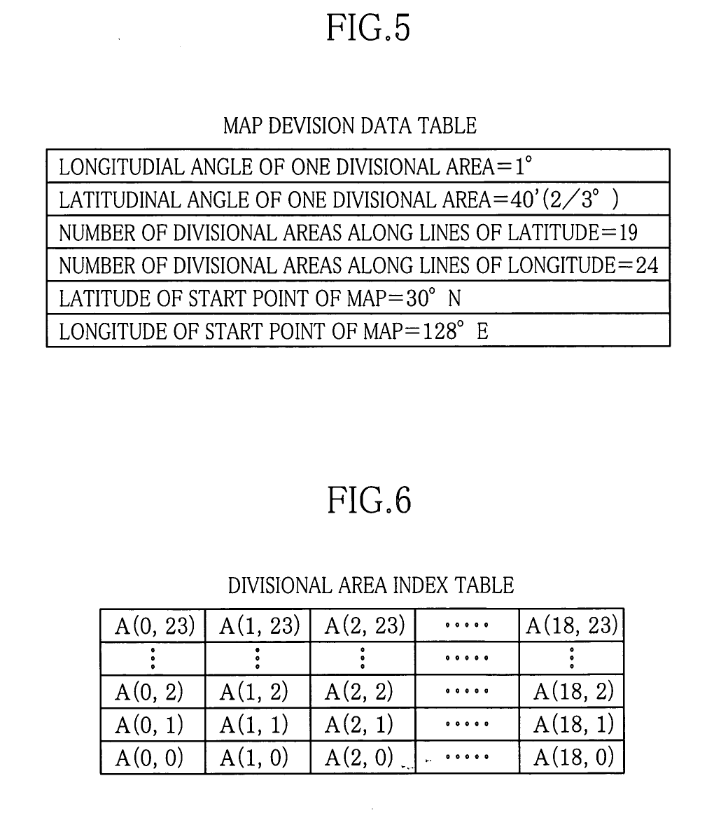

The map data is constituted of map division data table shown in FIG. 5 and divisional area index table shown in FIG. 6. The map division data table stores longitudinal and latitudinal angles of one divisional area, the number of divisional areas along lines of latitude, and the number of divisional areas along lines of longitude. The map division data table also stores latitude and longitude of the start point of the map. In the present embodiment, the longitudinal and latitudinal angles of one divisional area are 1° and 2/3°, respectively. The number of divisional areas along lines of latitude is 19, and the number of divisional areas along lines of longitude is 24. The latitude and the longitude of the start point are 30° N and 128° E, respectively.

The divisional area index table shown in FIG. 6 includes data of latitudes and longitudes of respective start points of all divisional areas. In FIG. 6, a couple of parenthetic numbers designate the place of each individual area relative to a start divisional area A(0,0) that is located at the start point of the map, the area hatched in FIG. 6. That is, the left parenthetic number of each area designates the number of order counted from the start area along latitude lines, whereas the right parenthetic number designates the number of order counted from the start divisional area A(0,0) along lines of longitude. For example, A(18,23) designates the divisional area including the end point of the map area, and A(10,15) designates the divisional area placed tenth from the start divisional area A(0,0) in the direction of latitude lines and fifteenth from the start divisional area A(0,0) in the direction of lines of longitude.

Although the map data is divided at 1° interval of longitude and at 40′(2/3°) interval of latitude in the embodiment shown in FIGS. 4 to 6, this is for the sake of avoiding complication. In practice, the map data is to be divided more finely. For example, the divisional areas of the map preferably have a length of 10 km or so along latitude lines and along longitude lines as well. Correspondingly to the smaller size of the divisional areas, the number of divisional areas along lines of latitudes and along lines of longitude will increase.

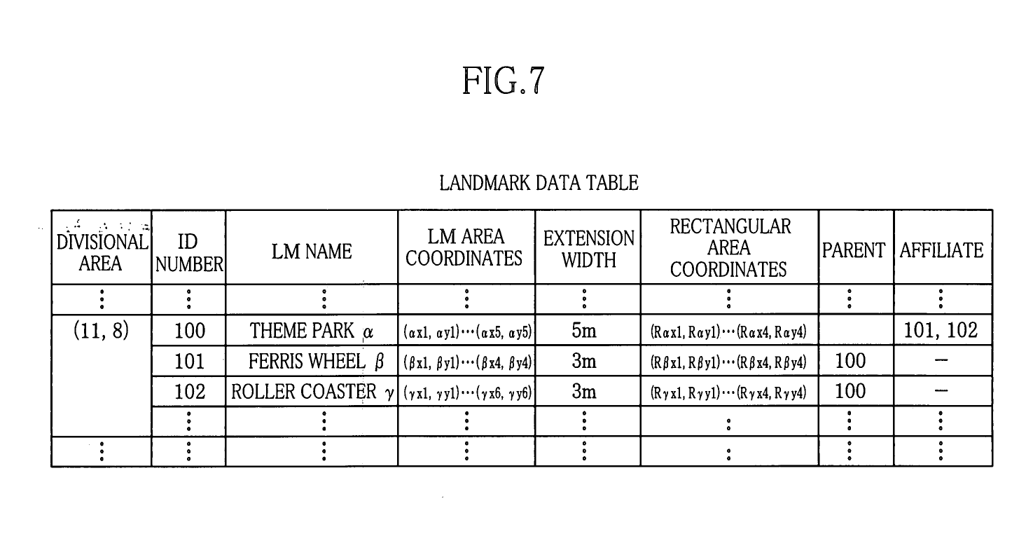

As shown in FIG. 7, the map data further include a landmark data table which stores place data, such as names of main landmarks, e.g. a theme park, a station and a school, which are located in the respective divisional areas, identification (ID) numbers assigned to the respective landmarks, area coordinates of the respective landmarks (LM area coordinates), extension widths, rectangular area coordinates, and parent data or affiliate data of the respective landmarks. In the present embodiment, an area A(11,8) will be described as an example where there is the theme park α, and the Ferris wheel β and the roller coaster γ are located in the theme park α.

The theme park α has an ID number #100, whereas the Ferris wheel β and the roller coaster γ have ID numbers #101 and #102 respectively. Since the Ferris wheel β and the roller coaster γ are located in the theme park α, they can be regarded as affiliates or subsidiaries of the theme park α in the relation of inclusion among the landmarks. Accordingly, the ID numbers #101 and #102 of the Ferris wheel β and the roller coaster γ are memorized in the affiliated data section of the theme park α, while the ID number #100 of the theme park α is memorized in the parent data sections of the Ferris wheel β and the roller coaster γ.

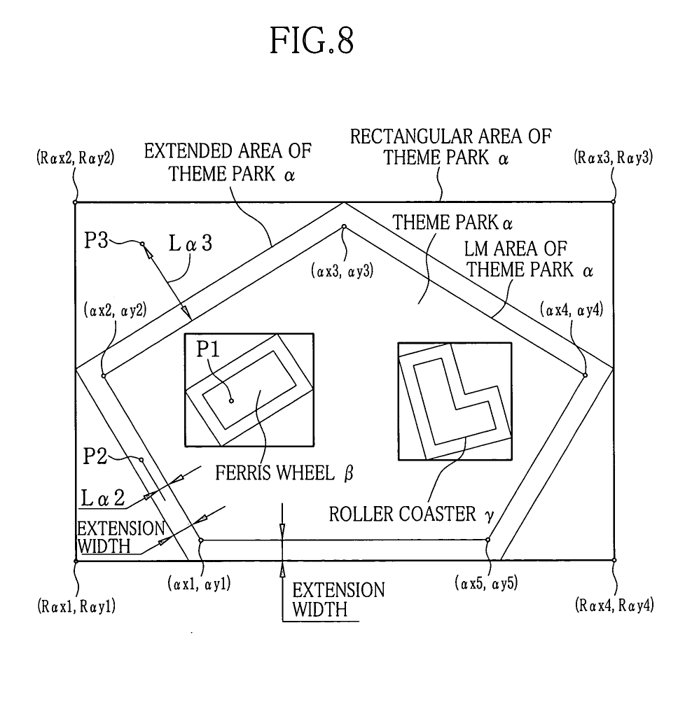

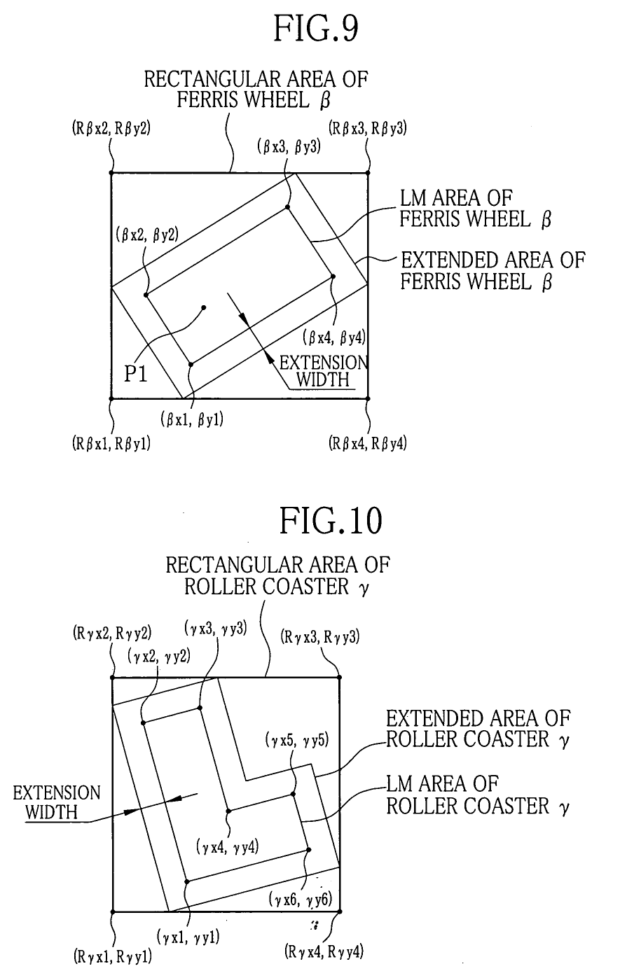

FIG. 8 shows area data of the theme park α schematically as a 2-D top plan view. The theme park α is a landmark having a pentagonal area, so data of coordinates (αx1, αy1), (αx2, αy2), (αx3, αy3), (αx4, αy4) and (αx5, αy5), which indicate respective latitudes and longitudes of the five vertexes, are memorized in the landmark area (LM area) coordinate section for the theme park α of the landmark data table, as shown in FIG. 9. The area bounded by lines extending between these vertexes may be called the landmark area of the theme park α. The area data further define an extended area of the theme park α, which is extended from the landmark area of the theme park α by a predetermined width in all directions. In the present example, the extension width from the landmark area to the extended area of the theme park α is 5 meters. Note that the extension width for each individual landmark is memorized in the extension width section of the landmark data table as shown in FIG. 7. Furthermore, the landmark data table includes data of a rectangular area of each landmark, or called a minimum bounding rectangle of each landmark, which circumscribes the extended area of each landmark. Specifically, data of coordinates indicating latitudes and longitudes of four vertexes of the rectangular area of the theme park α, i.e. (Rαx1, Rαy1), (Rαx2, Rαy2), (Rαx3, Rαy3) and (Rαx4, Rαy4) are memorized in the rectangular area coordinate section for the theme park α of the landmark data table, as shown in FIG. 9.

FIG. 9 shows area data of the Ferris wheel β schematically as a 2-D top plan view. The Ferris wheel β is a landmark having a rectangular area, so data of coordinates (βx1, βy1), (βx2, βy2), (βx3, βy3) and (βx4, βy4), which indicate respective latitudes and longitudes of the four vertexes, are memorized in the LM area coordinate section for the Ferris wheel β of the landmark data table as shown in FIG. 7. The area bounded by lines extending between these vertexes may be called the landmark area of the Ferris wheel β. The area data further define an extended area of the Ferris wheel β, which is extended by a predetermined width, e.g. 3 meters, in all directions from the landmark area of the Ferris wheel β. To define a rectangular area of the Ferris wheel β, which circumscribes vertexes of the extended area of the Ferris wheel β with latitudinal and longitudinal lines, data of coordinates indicating latitudes and longitudes of four vertexes of the rectangular area of the Ferris wheel β, i.e. (Rβx1, Rβy1), (Rβx2, Rβy2), (Rβx3, Rβy3) and (Rβx4, Rβy4) are memorized in the rectangular area coordinate section for the Ferris wheel β of the landmark data table as shown in FIG. 9.

FIG. 10 shows area data of the roller coaster γ schematically as a 2-D top plan view. The roller coaster γ is a landmark having a hexagonal area, so data of coordinates (γx1, γy1), (γx2, γy2), (γx3, γy3), (γx4, γy4), (γx5, γy5) and (γx6, γy6) which indicate respective latitudes and longitudes of the six vertexes, are memorized in the LM area coordinate section for the roller coaster γ of the landmark data table as shown in FIG. 7. The area bounded by lines extending between the six vertexes may be called the landmark area of the roller coaster γ. The area data further define an extended area of the roller coaster γ, which is extended by a predetermined width, e.g. 3 meters, in all directions from the landmark area of the roller coaster γ. To define a rectangular area of the roller coaster γ, which circumscribes vertexes of the extended area of the roller coaster γ with latitudinal and longitudinal lines, data of coordinates indicating latitudes and longitudes of four vertexes of the rectangular area of the roller coaster γ, i.e. (Rγx1, Rγy1), (Rγx2, Rγy2), (Rγx3, Rγy3) and (Rγx4, Rγy4), are memorized in the rectangular area coordinate section for the roller coaster γ of the landmark data table as shown in FIG. 7.

Referring back to FIG. 1, when the memory card 15 is connected to the memory card reader 8, the CPU 3 reads out the image data and the attached position data from the memory card 15. For example, the input position data designates a camera location P1 that is located at latitude 35.7° N and longitude 139.7° E. Then, the CPU 3 searches the landmark database DB1 based on the position data, to select one divisional area that includes the camera location from among all divisional areas of the map.

Specifically, in order to determine the divisional area that includes the entry position P1, the latitude of the start point of the map (=30° N) is reduced from the latitude of the camera location P1 (=35.7° N), and the value obtained by the reduction (=5.7°) is divided by the latitudinal angle of one divisional area (=2/3°). Then, decimal part of the quotient (=8.55) is rounded off. The numerical value (=8) obtained in this way indicates the number of order of the divisional area including the camera location P1, as counted along lines of longitude from the start divisional area A(0,0), the hatched area in FIG. 4. That is, the divisional area including the camera location P1 is determined to be one of the eighth areas from the start divisional area A(0,0) in the direction of lines of longitude.

Simultaneously, the longitude of the start point of the map (=128° E) is reduced from the longitude of the camera location P1 (=139.7° E), and the value obtained by the reduction (=11.7°) is divided by the longitudinal angle of one divisional area (=1°). Then, decimal part of the quotient (=11.7) is rounded off. The numerical value (=11) obtained in this way, indicates the number of order of the target divisional area as counted along lines of latitude from the start divisional area A(0,0). Consequently, the target divisional area including the camera location P1 is determined to be the area A(11,8) that is placed eleventh in the direction of latitude lines, and eighth in the direction of lines of longitude from the start divisional area A(0,0). Thus, the target divisional area including the camera location is determined by calculation based on the input position data, i.e. latitude and longitude of the camera location. This method saves time for searching the target divisional area including the camera location, in comparison with a case where the input position data are compared with all divisional areas of the map data on searching the target divisional area.

After the target divisional area is determined, the CPU 3 searches for a landmark relating to the camera location P1 with reference to the landmark data table. Since the camera location P1 is determined to be included in the divisional area A(11,8), the CPU 3 searches for merely those landmarks which are located in the area A(11,8). In the present example, the camera location P1 (35.7° N, 139.7° E) is assumed to be located at the Ferris wheel β in the theme park α, as shown in FIG. 6.

First, the CPU 3 retrieves at least a rectangular area that includes the camera location P1 among the rectangular areas of the landmarks located in the determined divisional area A(11,8). So the rectangular area of the theme park α, and the rectangular area of the Ferris wheel β are retrieved in this example.

Next, the CPU 3 calculates a distance Lα1 from the camera location P1 to the landmark area (LM area) of the theme park α, and a distance Lβ1 from the camera location P1 to the LM area of the Ferris wheel β. Concretely, the CPU 3 first judges whether a camera location P is inside or outside a LM area of a landmark, using a known method of judging whether a point is inside or outside a polygon. If the camera location P is inside the LM area, the distance L from the camera location P to the LM area is held to be zero. If not, the shortest distance from the camera location P to the LM area is decided to be the distance L. Since the camera location P1 is located at the Ferris wheel β in the theme park α, both the distance Lα1 from the camera location P1 to the LM area of the theme park α and the distance Lβ1 from the camera location P1 to the LM area of the Ferris wheel β are decided to be zero.

The landmark, of which the distance L from the camera location P is zero, is selected to be the landmark for the camera location P. Therefore, the theme park α and the Ferris wheel β (Lα1=0, Lβ1=0) are selected to be the landmarks for the camera location P1 (35.7° N, 139.7° E). When a plural number of landmarks are selected for one camera location P, the CPU 3 checks the parent data sections and the affiliate data sections of these landmarks. Then, among these landmarks, one landmark whose ID number is memorized in the parent data section of the other landmark, i.e. the theme park α in this example, is deleted from the candidates. Thus, the Ferris wheel β is finally selected as the landmark for the camera position P1 (latitude 35.7° and longitude 139.7°).

Next, the CPU 3 attaches Landmark data of the names of the finally selected landmarks to the image data, and thereafter writes the image file in the RAM 5. Instead of attaching the Landmark data to the image data, it is possible to memorize such data that associates the Landmark data with the image data in the RAM 5.

If the input position data represents such a camera location that the distance from the camera location to any LM area of any landmark is more than zero, the CPU 3 determines that the camera location is outside any LM areas of the determined divisional area. For example, if the input position data represent a camera location P2 that is located outside the theme park α but in the extended area of the theme park α, as shown in FIG. 8, the CPU 3 selects the theme park α as a landmark whose rectangular area includes the camera location P2. Next, the CPU 3 calculates a distance Lα2, that is the shortest distance from the camera location P2 to the LM area of the theme park α. Thereafter, the CPU 3 compares the distance Lα2 with the extension width for the theme park α, which is memorized in the extension width section for the theme park α of the landmark data table. If the distance Lα2 is not more than the extension width of the theme park α, the CPU 3 determines the theme park α to be the finally selected landmark, and outputs the Landmark data of the theme park α to the LCD panel 6, to display the finally selected landmark name. Simultaneously, the CPU 3 attaches the Landmark data of the finally selected landmark, i.e. the theme park α in this example, to the image data, and thereafter rewrites the image file in the RAM 5.

If the input position data represent a camera location P3 that is located outside the extended area of the theme park α but in the rectangular area of the theme park α, as shown in FIG. 8, the CPU 3 selects the theme park α as a landmark whose rectangular area includes the camera location P3. Next, the CPU 3 calculates a distance Lα3, that is the shortest distance from the camera location P3 to the LM area of the theme park α. Thereafter, the CPU 3 compares the distance Lα3 with the extension width for the theme park α. Note that, if there are a number of landmarks whose rectangular areas include the camera location P3, only the distance L to the nearest landmark is compared with the extension width of the nearest landmark.

Because the distance Lα3 is more than the extension width of the theme park α, the CPU 3 does not determine the theme park α to be the finally selected landmark. That is, the camera location P3 is judged to be outside any landmark. In that case, the CPU 3 outputs data of a message that the camera location of this image is outside the main landmarks, to the LCD panel 6, to let the LCD panel 6 display this message. Simultaneously, the CPU 3 attaches the data of this message to the image data, and thereafter rewrites the image file in the RAM 5.

As described so far, the CPU 3 reads out the image files from the memory card 15, attaches the landmark data to the image data and thereafter stores the image files in the RAM 5, wherein the CPU 3 sorts the image files into groups according to the attached landmark data, and stores the image files of one group, which have the same landmark data, in a folder that has the same name as the landmark name designated by the common landmark data to this group. Thus, according to the image editor program, the image files are read out from the memory card 15 and grouped, and if necessary, their landmark data are corrected. After the completion of these processes, the user operates the operating section 7 to start an image editing process for producing a digital photo-album.

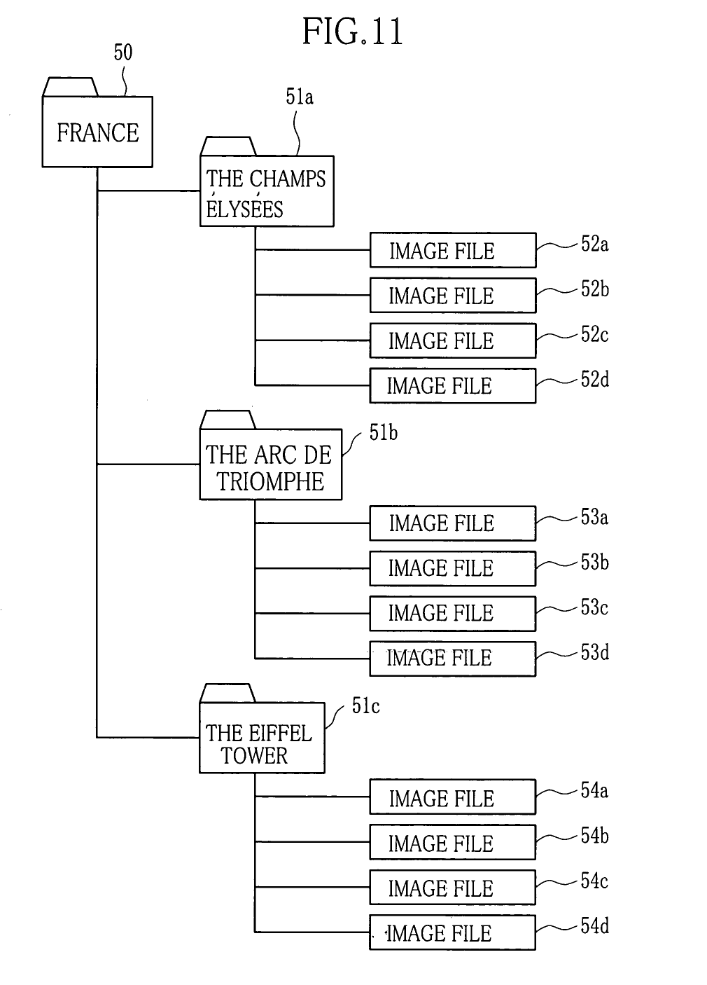

The image editing process for producing a digital photo-album will be described with respect to an embodiment shown in FIGS. 11 to 13. A folder 50 shown in FIG. 11 is structured in the same way as above, by attaching the landmark data to the image data of a plural number of images, to produce image files, and sorting the image files into groups according to the attached landmark data. In this example, the folder 50 is named “France”, and includes subfolders 51a, 51b and 51c named “The Champs Elysees”, “The Arc de Triomphe” and “The Eiffel Tower”. The respective subfolders 51a to 51c store image files 52a to 52d, 53a to 53d, and 54a to 54d. The number of folders and the number of image files are not limited to this example. The subfolder 51a named “The Champs Elysees” stores the image files 52a to 52d whose landmark data represent “France/The Champs Elysees”. The subfolder 51b named “The Arc de Triomphe” stores the image files 53a to 53d whose landmark data represent “France/The Arc de Triomphe”. The subfolder 51c named “The Eiffel Tower” stores the image files 54a to 54d whose landmark data represent “France/The Eiffel Tower”.

Now the image editing process using the image files 52a to 52d, 53a to 53d, and 54a to 54d of the above-mentioned folder 50 will be described with respect to two cases. In one case, the user carries out the editing process by oneself to produce a digital photo-album or digital photo-movie, after obtaining the contents data relating to the landmark data. In another case, the processes of obtaining the contents data relating to the landmark data and producing a digital photo-album by composing the image data with the contents data are automatically carried out by an image editing program. First, the automatic image editing process will be described.

When the image editor program is activated, the LCD panel 6 displays the image sorting screen 30 as shown in FIG. 2. After the selection of the folder 50 to edit is confirmed on the image sorting screen 30, for example, by displaying the folder 50 in the explorer window 32 or by clicking on the folder 50 to invert the display condition of the folder 50 from other folders in the explorer window 32, an image edit button 35A or a contents data obtaining button 35B of the explorer window 32 is clicked, to start the image editing process. Upon clicking on the edit button 35A, the automatic process for producing a digital photo-album gets started.

In the automatic process, the CPU 3 reads the landmark data of the image files 52a to 52d, 53a to 53d, and 54a to 54d of the folder 50 from the RAM 5, and reads the contents data relating to the read landmark data from the contents data base DB2. At that time, the CPU 3 first reads such contents data that relates to the landmark “France”, which is used for the name of the folder 50. Next, the CPU 3 sequentially reads such contents data that relates to the landmarks which are used for the names of the subfolders 51a to 51c, i.e. “The Champs Elysees”, “The Arc de Triomphe” and “The Eiffel Tower” in this example. In other words, the CPU 3 reads the contents data sequentially from those relating to a larger place or landmark to those relating to a smaller place or landmark, which are located or included in the larger place or landmark.

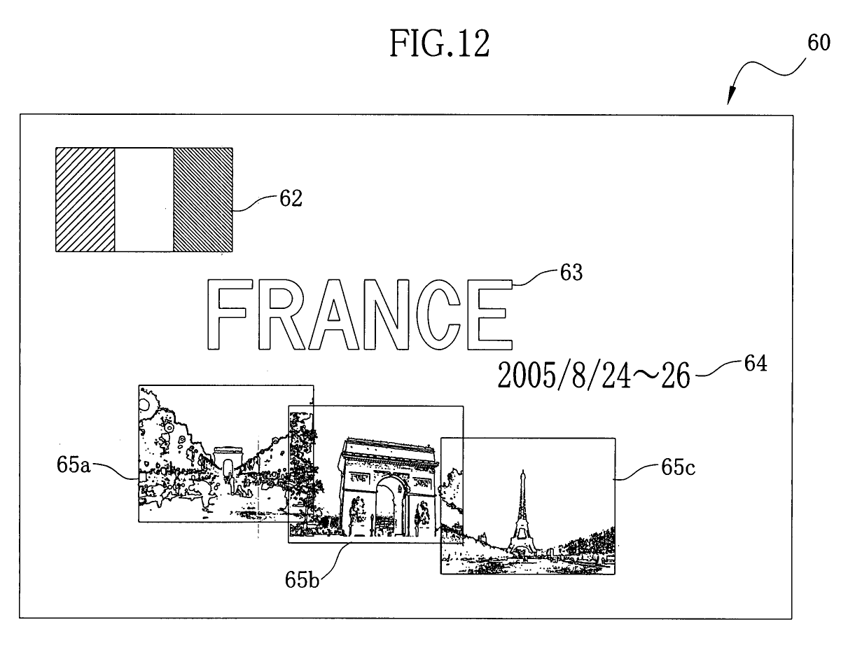

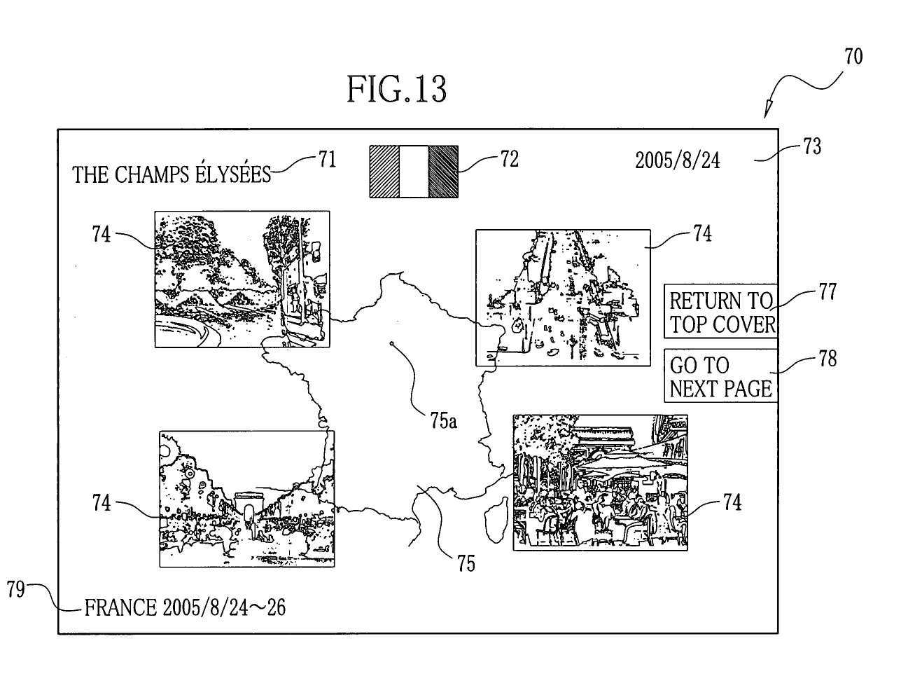

In the present embodiment, as described above, a digital photo-album is produced by using and editing the image files 52a to 52d, 53a to 53d, and 54a to 54d of the folder 50 named “France” and the contents data relating to the landmark data attached to these image files 52a to 52d, 53a to 53d, and 54a to 54d. The digital photo-album produced by the image editor 2 consists of such images 60 and 62 as shown in FIGS. 12 and 13, hereinafter these images 60 and 62 obtained through the image editing process will be called layout images. To constitute the digital photo-album, first the layout image 60 shown in FIG. 12 is produced for the album top cover. The layout image 60 contains an image of the national flag 62, title 63, date 64, and representative pictures 65a to 65c arranged in this order from the top. Contents data relating to the title or name of the folder 50 is used for the title 63. For example, image data of logotypes for “France” is read out from the contents database DB2, and used for the title 63. As for the date 64, date data attached to the image files 52a to 52d, 53a to 53d, and 54a to 54d are read out. For example, if the date data indicates the 24^{th} Aug., the 25^{th} Aug. and the 26^{th} Aug. 2005, an indicia “2005/8/24˜26” is read as the contents data to be used for the date 64.

The representative pictures 65a to 65c are selected from among the image files 52a to 52d, 53a to 53d, and 54a to 54d of the respective subfolders 51a to 51c, wherein the user may select an appropriate one as the representative image 65a, 65b or 65c for each subfolder 51a, 51b or 51c. Alternatively, the first-stored image files 52a, 53a and 54a in the respective subfolders 51a to 51c may automatically be selected as the representative pictures 65a to 65c. The representative pictures 65a to 65c are also set up as menu irons for linkage to those pages of the digital photo-album which correspond to the respective subfolders 51a to 51c titled “The Champs Elysees”, “The Arc de Triomphe” and “The Eiffel Tower”. Therefore, the user clicks on any of the representative pictures 65a to 65c, to switch the screen to the page containing layout images as produced from the image files 52a to 52d, 53a to 53d, or 54a to 54d of the corresponding subfolder 51a, 51b or 51c.

For the top cover layout image 60, the contents data relating to “France”, image data of the national flag of France, called the Tricolor, is read from the contents database DB2, and is arranged in the way as designated by 62. As the contents data used for producing a layout image as the top cover of the digital photo-album, any other contents relating to the named place, i.e. France in this example, are usable. For example, a map, a specialty, a public figure of France or the like is usable.

Next, the layout images are produced based on the image files 52a to 52d, 53a to 53d, and 54a to 54d of the respective subfolders 51a to 51c. FIG. 13 shows an example of such layout image 70 that is produced based on the image files 52 to 52d of the subfolder 51b titled “Champs Elysees” and contents data relating to this landmark.

The layout image 70 contains a page title 71, an image of the national flag 72, date 73, pictures 74, a map of France 75, a button 77 for returning to the top cover, a button 78 for proceeding to the next page and an album title 79. Contents data relating to the title of the subfolder 51a “The Champs Elysees” is used for the title 71. As for the date 73, date data attached to the image data of the image files 52a to 52d of the subfolder 51a are read out, and contents data relating to the read date data is retrieved and used. For the map of France 75, image data of a geographical image of France indicating the location of the Champs Elysees with a pointing mark 75a is used in this example. The pictures 74 based on the image files 52a to 52d of the subfolder 51a are arranged with adequate spacing around the map of France 75. When the user clicks on the button 77, the screen returns to the top cover 60 of the digital photo-album. When the user clicks on the button 78, the screen goes to the next page that contains for example a layout image produced based on the image files 53a to 53d of the subfolder 51b titled “The Arc de Triomphe”. The album title 79 is produced based on the image data of logotypes for “France” and the date data as used for the top cover layout image 60.

In the same way as for the layout image 70, layout images are produced based on the image files 53a to 53d of the subfolder 51b and the image files 54a to 54d of the subfolder 51c. The produced digital photo-album may be displayed or reproduced on a specific reproduction program or a general-purpose display program like the Internet Explorer (a trade name). On reproducing the digital photo-album, first the top cover layout image 60 is displayed. By clicking on one of the representative pictures 65a to 65c, a corresponding one of the layout images of the respective subfolders 51a to 51c, e.g. the layout image 70, is displayed in place of the layout image 60. In this way, the digital photo-album permits looking layout images where all images are sorted and put in order on the basis of the landmark data. Furthermore, the user can easily search for an expected picture, using a related landmark or the date of capturing that picture as a keyword or index.

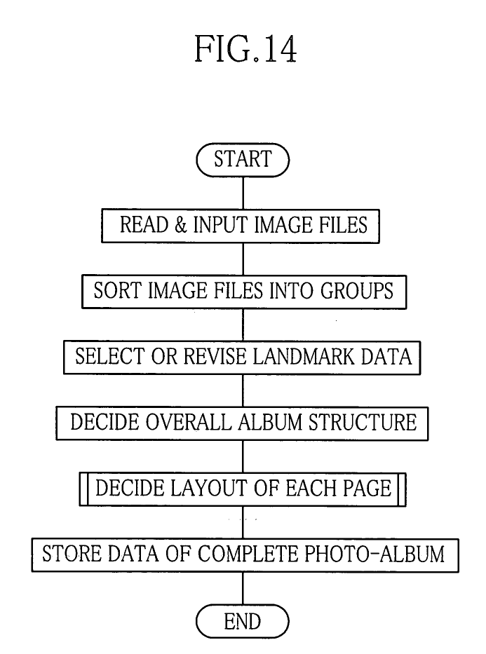

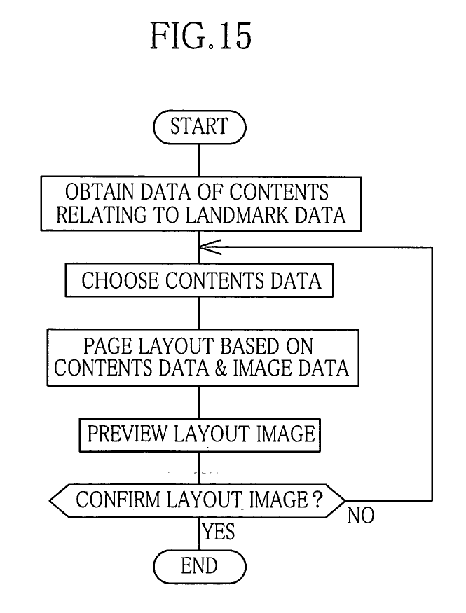

Now the operation of the image editor 2 on producing a digital photo-album will be described with reference to the flowcharts of FIGS. 14 and 15. FIG. 14 shows the overall operation for producing the digital photo-album, whereas FIG. 15 shows the operation for deciding layout of each page. When the memory card 15 is connected to the memory card reader 8, the CPU 3 reads out image files from the memory card 15, and stores the image files in the RAM 5. Next, the CPU 3 searches the landmark database DB1 based on the position data attached to the image data of the respective image files, to retrieve the landmarks corresponding to the camera locations of the respective images. Then the CPU 3 attaches data of the retrieved landmarks to the respective image files, and thereafter rewrites the image files in the RAM 5.

When the image editor program is activated, the CPU 3 displays the image sorting screen 30. Simultaneously, the CPU 3 sorts the image files into groups according to the attached landmark data, and stores each group of the image files as a folder titled with the name of the associated landmark again in the RAM 5. At that time, the user selects or revises the landmark name while observing the image sorting screen 30 and the image confirmation screen 40. After the image file grouping and the landmark name correction are finished, the user selects an appropriate folder and operates the image edit button 35A, to start the image editing process on the selected folder.

At the start of the image editing process, the CPU 3 decides the overall structure of the digital photo-album, such as the layout of the top cover, the link from the top cover to individual pages. Next, the CPU 3 reads out the landmark data from the image files of the selected folder, and retrieves the contents data from the contents database DB2, in correspondence with the landmark data. As shown in FIG. 15, if a lot of contents data are retrieved for one landmark data, the CPU 3 allows the user to choose desirable ones from among, so as to use the chosen contents data alone for producing the digital photo-album. Then the CPU 3 uses the contents data for editing the image files of the selected folder, to produce layout images of the digital photo-album. After the layout images are produced, previews of the layout images are displayed on the LCD panel 6. For example, the thumbnail window 34 of the image sorting screen 30 is switched to a preview window for displaying the previews one after another. It is alternatively possible to display the preview window besides the windows of the image sorting screen 30. The user checks if the previewed layout image is satisfactory, and confirms the previewed layout image if it satisfies the user, for example, by clicking on an enter button 35C in the operation menu window 35 (see FIG. 2). If the reviewed layout image does not satisfy the user, the user can cancel this layout image, for example, by clicking on a cancel button 35D in the operation menu window 35. Then, it becomes possible to produce another layout image instead. After the layout images for all pages of the digital photo-album are produced and confirmed in this way, data of the complete digital photo-album is stored in the HDD 9, to conclude the image editor program, as shown in FIG. 14.

As described so far, the landmark data is retrieved based on the position data, the image files attached with the same landmark data are put into the same group, and the contents data relating to the landmark data is obtained for use in editing the images. Therefore, the image editor 2 makes it possible to edit a large number of images automatically to have suitable contents for the camera locations of the respective images, and thus makes it easy to produce highly-entertaining digital photo-albums. Since the digital photo-album shows the pictures in groups sorted according to the landmarks, the digital photo-album facilitates reminding the user of the events shot in the pictures.

Although the present invention has been described with respect to the embodiment where the digital photo-album is automatically produced based on the contents data relating to the landmark data attached to the image data, the present invention is not to be limited to this embodiment. After the contents data is obtained based on the landmark data, the user may edit the image data manually by entering editorial conditions or the like, using an application other than the image editor program.

In the above embodiment, the image data and the contents data are used for producing the digital photo-album automatically. It is also possible to produce a digital photo-movie by obtaining data of moving images, data of voice or sound, program for special effects or the like as contents data, and editing the image data with the contents data in a manner as set forth below. An apparatus for this embodiment may have the same structure as the above-described image editor 2, so it is not especially illustrated in the drawings.

The present embodiment executes the processes of retrieving the landmark data based on the position data attached to the image data, grouping the image data according to the landmarks, and obtaining the contents data relating to the landmarks, in the same way as described in the above embodiment. Unlike the above embodiment, program for giving special effects to still images, data of motion pictures, and audio data like data of music are stored as contents data for digital photo-movies in a contents database DB2, in addition to the same contents data as used in the above embodiment, i.e. image data and text data relating to the landmarks.

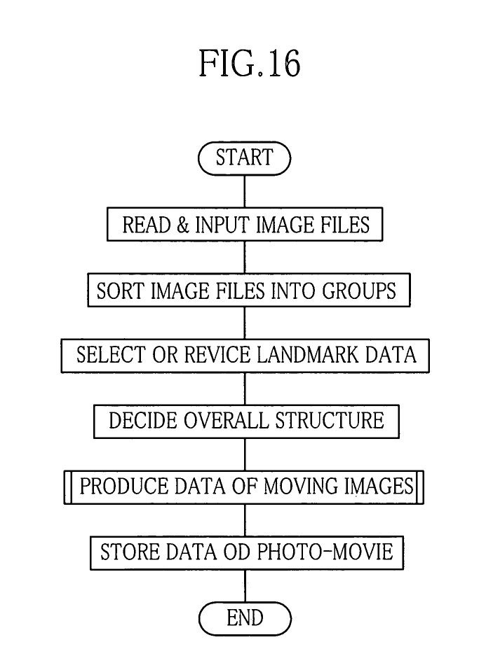

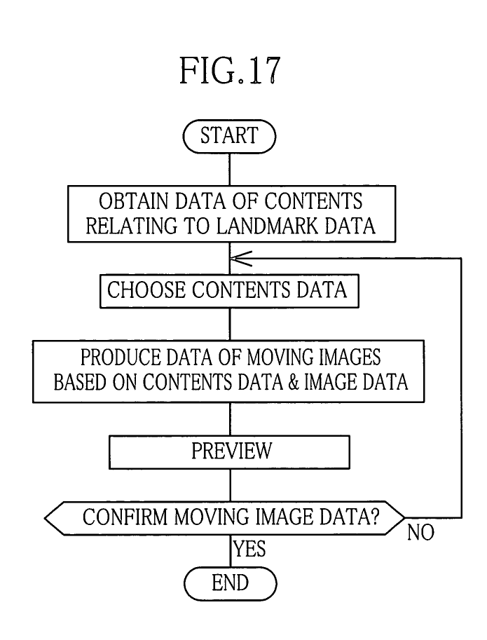

Now the operation for producing a digital photo-movie will be described with reference to the flowcharts of FIGS. 16 and 17. FIG. 16 shows the overall operation for producing the digital photo-movie, whereas FIG. 17 shows the operation for producing data of moving images. When a memory card 15 is connected to the memory card reader 8, a CPU 3 reads out image files from the memory card 15, and stores the image files in a RAM 5. Next, the CPU 3 searches a landmark database DB1 based on the position data attached to the image data of the respective image files, to retrieve the landmarks corresponding to the camera locations of the respective images. Then the CPU 3 attaches data of the retrieved landmarks to the respective image files, and thereafter rewrites the image files in the RAM 5.

When the image editor program is activated, the CPU 3 sorts the image files into groups according to the attached landmark data, and stores each group of the image files as a folder titled with the name of the associated landmark again in the RAM 5. At that time, the user selects or revises the landmark name. After the image file grouping and the landmark name correction are finished, the user selects an appropriate folder and operates an image edit button 35A on an image sorting screen 30, to start the image editing process on the selected folder.

At the start of the image editing process, the CPU 3 decides the overall structure of the digital photo-movie. Next, the CPU 3 reads out the landmark data from the image files of the selected folder, and retrieves the contents data from the contents database DB2, in correspondence with the landmark data. As shown in FIG. 17, among the obtained contents data, including program for giving special effects to still images, data of motion pictures, audio data, image data and text data, the user choose some. Then, using and editing the chosen contents data and the image files of the selected folder, data of moving images for the digital photo-movie is produced. After the data of moving images are produced, previews of the moving images are displayed on an LCD panel 6, so that the user checks if the previewed moving images are satisfactory. For example, a thumbnail window 34 of the image sorting screen 30 is switched to a preview window. If the previewed moving images satisfy the user, the user confirms them. If not, the user can cancel the moving images. Then, it becomes possible to produce another set of moving images instead. After the moving images for the digital photo-movie are produced and confirmed in this way, data of the complete digital photo-movie is stored in an HDD 9, to conclude the image editor program, as shown in FIG. 16.

As described so far, the landmark data is retrieved based on the position data, the image files attached with the same landmark data are put into the same group, and the contents data relating to the landmark data is obtained for use in editing the images. Therefore, the present embodiment makes it possible to edit a large number of images automatically to have suitable contents for the camera locations of the respective images, and thus makes it easy to produce highly-entertaining digital photo-movies. Since the digital photo-movie is produced after the pictures are sorted into groups according to the landmarks, the digital photo-movie facilitates reminding the user of the events shot in the pictures.

In the above embodiments, the image editor 2 is provided with the HDD 9 that stores the landmark database DB1 and the contents database DB2. It is alternatively possible to store the landmark database and the contents database in a data server that is accessible through a network, so that the landmark data and the contents data may be retrieved from the data server.

Although the present invention has been described with respect to the preferred embodiments, the present invention is not to be limited to the above embodiments but, on the contrary, various modifications will be possible without departing from the scope of claims appended hereto.

What is claimed is:

1. An image editing system for editing image data, wherein position data is attached to the image data, indicating a camera location at which each image is captured, said system comprising:
a landmark database storing data of a variety of landmarks, including locations and names of the landmarks;
a contents database storing contents data that include data relating to the respective landmarks and data for giving some effect to the images;
a device for obtaining the image data of a plural number of images along with the position data;
a search device for searching said landmark database, to retrieve such landmark data based on the position data that relates to the camera location of each image;
a sorting device for sorting the image data into groups according to the retrieved landmark data, while associating the retrieved landmark data with the corresponding image data; and
an image editing device that obtains from said contents database such contents data that relates to the landmark data associated with the image data of one group, to edit the image data of this group by use of the obtained contents data.

2. An image editing system as claimed in claim 1, wherein the landmark data include data of inclusive relation between the landmarks, and said image editing device reads the contents data sequentially from those relating to a larger place or landmark to those relating to a smaller place or landmark that is located in said larger place or landmark, to edit the corresponding image data by use of the contents data for the larger place or landmark, and the contents data for the smaller place or landmark in combination.

3. An image editing system as claimed in claim 1, further comprising a device for setting priority among a plural number of landmarks as retrieved based on the position data for one image, and a device for selecting a landmark from among the plural number of landmarks as displayed in a sequence according to the set priority.

4. An image editing system as claimed in claim 3, wherein among the landmarks retrieved for one image the nearer landmark to the camera location of said one image is given the higher priority.

5. An image editing system as claimed in claim 1, wherein said image editing device produces a digital photo-movie from the image data in combination with the contents data.

6. An image editing system as claimed in claim 1, wherein said image editing device produces a digital photo-album from the image data in combination with the contents data.

7. An image editing system as claimed in claim 1, wherein said landmark database and said contents database are stored in a built-in storage device that is incorporated with other devices into a unit.

8. An image editing system as claimed in claim 1, wherein said landmark database and said contents database are stored in an external data server, to which said search device and said image editing device are accessible through a communication device.

9. An image editing system as claimed in claim 2, further comprising a storage device for storing the image data of each group in a folder having the name of the associated landmark, and the folders of the respective groups are tree-structured corresponding to the inclusive relation between the landmarks.

10. An image editing program for editing image data, wherein position data is attached to the image data, indicating a camera location at which each image is captured, said program makes a computer execute the following processes of:
obtaining the image data of a plural number of images along with the position data;
searching a landmark database based on the position data, said landmark database storing data including locations and names of a variety of landmarks, to retrieve data of at least a landmark that relates to the camera location of each image;
sorting the image data into groups according to the retrieved landmark data, while associating the retrieved landmark data with the image data;
obtaining from a contents data base such contents data that relates to the landmark data associated with the image data of one group, said contents database storing contents data that include data relating to the respective landmarks and data for giving some effect to the images; and
editing the image data of said one group by use of the obtained contents data.

11. An image editing program as claimed in claim 10, wherein the landmark data include data of inclusive relation between the landmarks, and the contents data is obtained sequentially from those relating to a larger place or landmark to those relating to a smaller place or landmark that is located in said larger place or landmark, to edit the corresponding image data by use of the contents data for the larger place or landmark, and the contents data for the smaller place or landmark in combination.

12. An image editing program as claimed in claim 10, said program further makes the computer execute a process for setting priority among a plural number of landmarks as retrieved based on the position data for one image, and a process for selecting a landmark from among the plural number of landmarks as displayed in a sequence according to the set priority.

13. An image editing program as claimed in claim 12, wherein among the landmarks retrieved for one image the nearer landmark to the camera location of said one image is given the higher priority.

14. An image editing program as claimed in claim 10, wherein said image/editing process produces a digital photo-movie from the image data in combination with the contents data.

15. An image editing program as claimed in claim 10, wherein said image editing process produces a digital photo-album from the image data in combination with the contents data.
